(19) United States
(12) Patent Application Publication
(10) Pub. No.: US 2014/0025224 A1
(43) Pub. Date: Jan. 23, 2014

(54) ELECTRONIC DEVICE WITH MULTIPLE TOUCH SENSING MODULES AND HEAT DISSIPATING CONTROL METHOD THEREOF

(71) Applicants: Chun-Chieh Wong, Taipei City (TW); Cheng-Yu Wang, Taipei City (TW)

(72) Inventors: Chun-Chieh Wong, Taipei City (TW); Cheng-Yu Wang, Taipei City (TW)

(73) Assignee: ASUSTeK COMPUTER INC., Taipei City (TW)

(21) Appl. No.: 13/922,264

(22) Filed: Jun. 20, 2013

(30) Foreign Application Priority Data
Jul. 18, 2012 (TW) 101125871

(51) Int. Cl. G06F 1/20

(52) U.S. Cl. CPC G06F 1/203
USPC 700/300

(57) ABSTRACT

An electronic device with a plurality of touch sensing modules and a heat dissipating control method thereof are provided. The heat dissipating control method includes following steps: detecting whether an object approaches the electronic device or the electronic device is touched to generate a sensing result; recognizing an executable scenario solution according to the sensing result, and cooling the electronic device according to the executable scenario solution.

### CROSS-REFERENCE TO RELATED APPLICATION

This application claims the priority benefit of Taiwan application serial No. 101125871, filed on Jul. 18, 2012. The entirety of the above-mentioned patent application is hereby incorporated by reference herein and made a part of specification.

### BACKGROUND OF THE INVENTION

1. Field of the Invention

The disclosure relates to an electronic device with a plurality of touch sensing modules and a heat dissipating control method thereof.

2. Description of the Related Art

Conventionally, a user may use a notebook computer at a desk or any other place. In a specific operating state, the user may place the notebook computer on legs or hold it by hands. Since fingers, palms or legs are sensitive to temperature, the user may feel uncomfortable in operation as the surface temperature of the notebook computer increases.

Although the notebook computer usually includes a heat dissipating mechanism to enhance cooling effect and reduce the whole temperature when the system load becomes heavy. However the heat dissipating mechanism operates based on the system load, and it does not take different operating states into account.

### SUMMARY OF THE INVENTION

A heat dissipating control method applied to an electronic device with a plurality of touch sensing modules is provided. The heat dissipating control method includes following steps: detecting whether an object approaches the electronic device or the electronic device is touched to generate a sensing result; recognizing an executable scenario solution according to the sensing result, and cooling the electronic device according to the executable scenario solution. In an embodiment, the heat dissipating control method adjusts a rotating speed of a fan and an operation power consumption to reduce surface temperature of a casing of the electronic device.

An electronic device which can control heat dissipating according to an operating state is also provided. The electronic device includes a casing, a motherboard, a scenario detecting circuit and a scenario controller. The casing includes a bottom casing and an upper casing to form accommodating space. The motherboard is disposed in the accommodating space. The scenario detecting circuit includes a plurality of touch sensing modules. The touch sensing modules are disposed at an inner surface of the casing, and the scenario detecting circuit detects whether an object approaches the electronic device or the electronic device is touched to generate a sensing result. The scenario controller is disposed at the motherboard. The scenario controller receives the sensing result, recognizes an executable scenario solution according to the sensing result, and controls the heat dissipating of the electronic device according to the executable scenario solution.

As stated above, the rotating speed of the fan and the operation power consumption of the electronic device can be adjusted according to the scenario solutions suitable for the user, and the surface temperature of the casing which contacts with the user can be reduced efficiently.

These and other features, aspects and advantages of the present disclosure will become better understood with regard to the following description, appended claims, and accompanying drawings.

### BRIEF DESCRIPTION OF THE DRAWINGS

FIG. 1 is a schematic diagram showing an electronic device in an embodiment;

FIG. 2A is a schematic diagram showing a bottom casing and touch detecting areas of the electronic device in FIG. 1;

FIG. 2B is a schematic diagram showing an upper casing and touch detecting areas of the electronic device in FIG. 1;

FIG. 3A is a block diagram showing a circuit of the electronic device in FIG. 1 in a first embodiment;

FIG. 3B is a schematic diagram showing operating states in an embodiment;

FIG. 3C is a block diagram showing a circuit of an electronic device in a second embodiment;

FIG. 3D is a block diagram showing a circuit of an electronic device in a third embodiment; and

FIG. 4 is a flow chart showing a heat dissipating control method in an embodiment.

### DESCRIPTION OF THE PREFERRED EMBODIMENTS

A heat dissipating control method applied to an electronic device with a plurality of touch sensing modules and an electronic device using the same are illustrated with relating figures. The same symbols denote the same components.

When an element is described as being at, connected to or coupled to another element, it may be directly at, connected to or coupled to another element, or it uses an intervention element. Relatively, when an element is described as directly being at, connected to or coupled to another element, it does not use an intervention element.

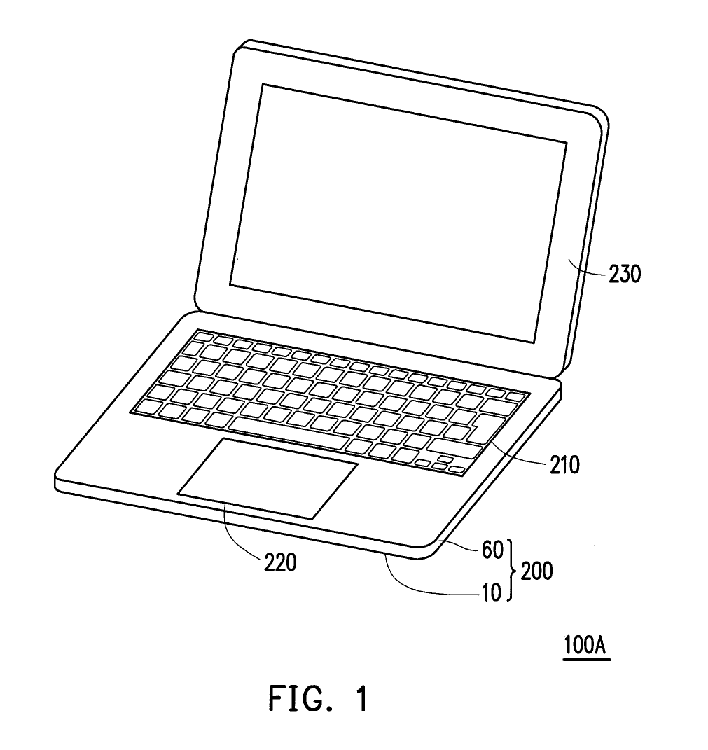

FIG. 1 is a schematic diagram showing an electronic device in an embodiment. As shown in FIG. 1, the electronic device 100A is a notebook computer, and it may also be a tablet computer or a mobile phone, which is not limited herein.

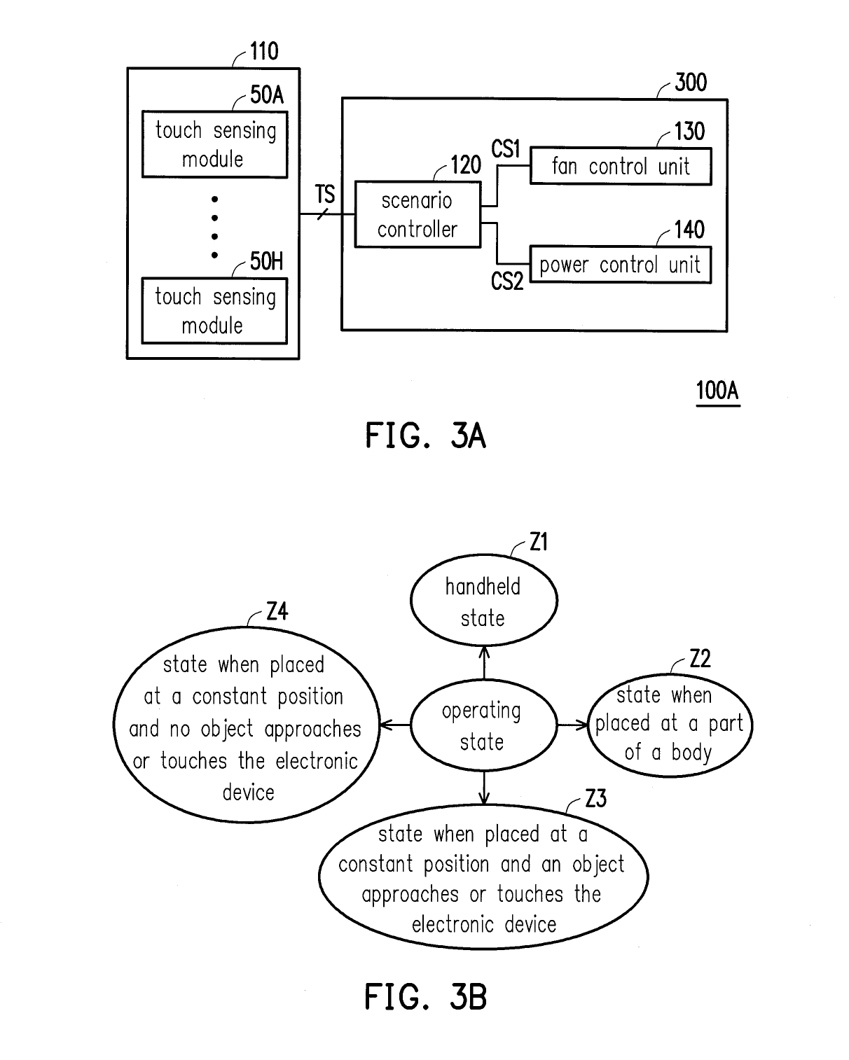

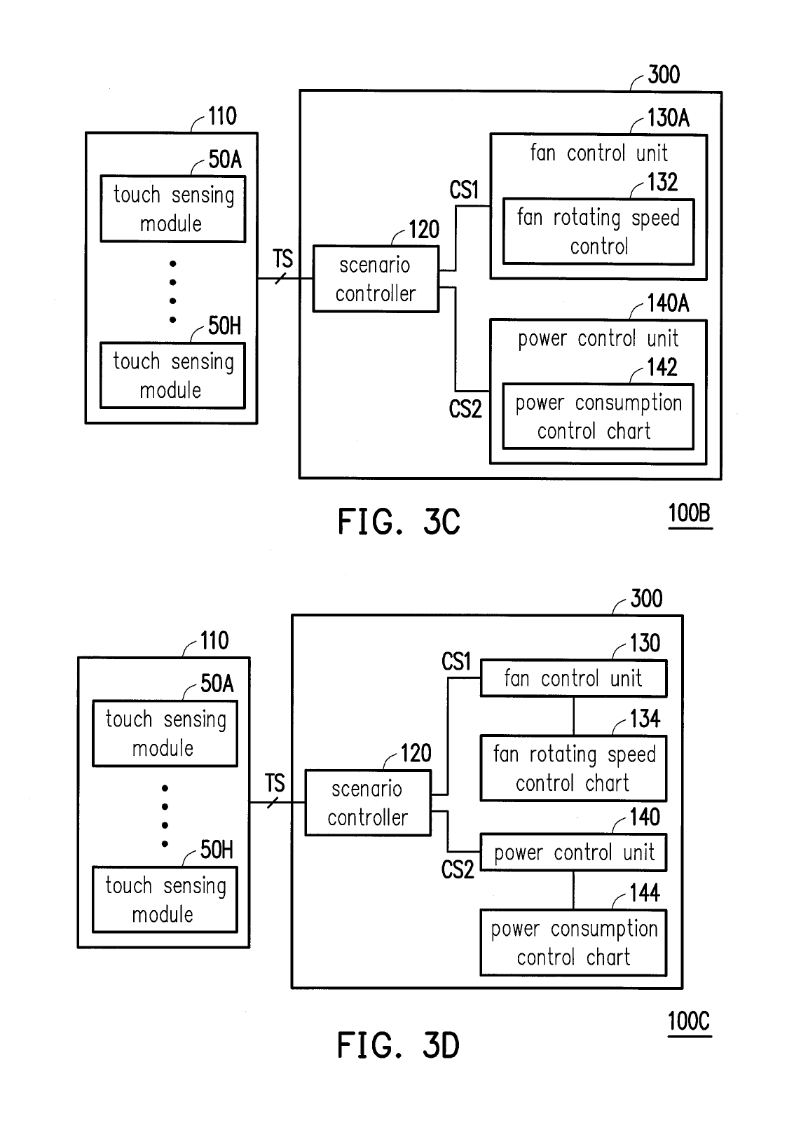

Please refer to FIG. 1, the electronic device 100A includes a casing 200 and a motherboard (an element 300 shown in FIG. 3A). The casing 200 includes a bottom casing 10 and an upper casing 60. The bottom casing 10 is combined with the upper casing 60 to form an accommodating space where the motherboard is disposed inside.

Moreover, a keyboard module 210 and a touch pad 220 are disposed at the upper casing 60. The keyboard module 210, the touch pad 220 and the display panel 230 can be removed and a touch control panel is disposed at the upper casing 60, which means the electronic device 100A is a tablet computer.

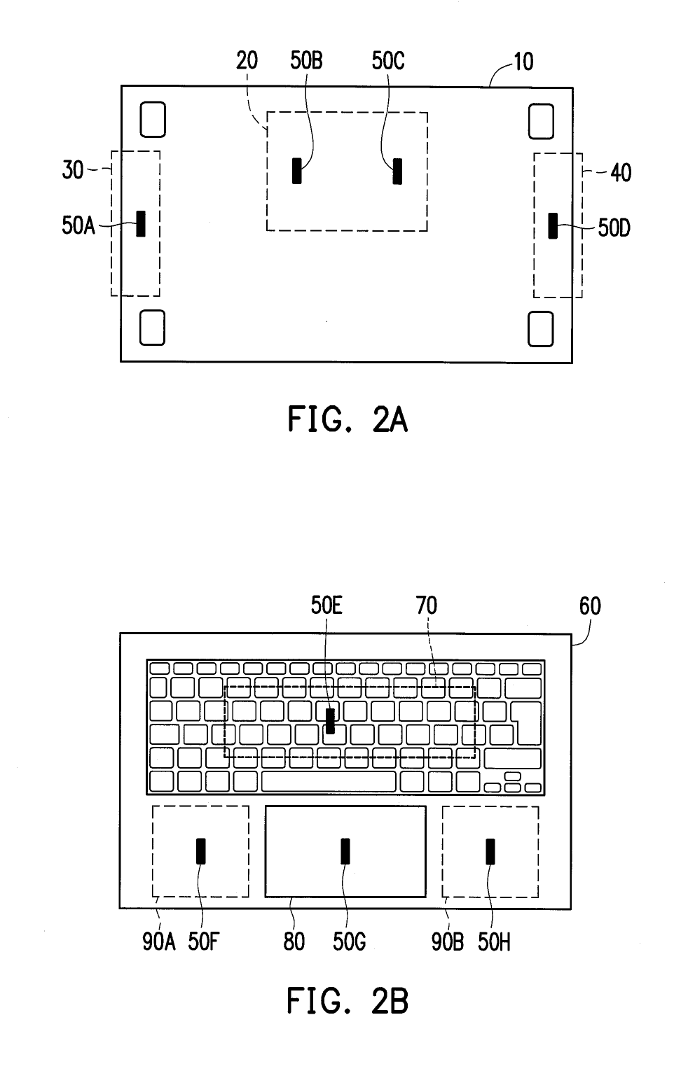

FIG. 2A is a schematic diagram showing a bottom casing and touch detecting areas of the electronic device in FIG. 1. FIG. 2B is a schematic diagram showing an upper casing and touch detecting areas of the electronic device in FIG. 1. Please refer to FIG. 2A, the bottom casing 10 of the electronic device 100A has an inner surface and an outer surface. The inner surface faces the accommodating space, and the outer surface faces a placing position (such as a desk) of the electronic device. The touch detecting areas at the outer surface of the bottom casing 10 include a first side detecting area 30, a middle detecting area 20 or a second side detecting area 40.

The first side detecting area 30 and the second side detecting area 40 may be located at opposite sides of the middle detecting area 20, and the position and number of the detecting areas are not limited herein.

In order to detect an approach or a touch event from a user, a plurality of touch sensing modules 50A to 50D (which are shown in black blocks in FIG. 2A) are disposed at the touch detecting area of the bottom casing 10.

In this embodiment, the touch sensing modules 50A to 50D are disposed at the inner surface of the bottom casing 10, and the touch sensing modules 50A to 50D detect a touch at the touch detecting area at the outer surface of the bottom casing 10. For example, when the touch sensing module 50A is disposed at the first side detecting area 30 of the bottom casing 10, the touch sensing module 50A may detect any approach or touch event at the first side detecting area 30. Similarly, when the touch sensing modules 50B and 50C are disposed at the middle detecting area 20 of the bottom casing 10, the touch sensing modules 50B and 50C may detect any approach or touch event at the middle detecting area 20. When the touch sensing modules 50D is disposed at the second side detecting area 40 of the bottom casing 10, the touch sensing modules 50D detects any approach or touch event at the second side detecting area 40.

Please refer to FIG. 2B, the upper casing 60 of the electronic device includes an inner surface and an outer surface. The inner surface faces the accommodating space. The input components or output components are disposed at the outer surface. The touch detecting areas at the outer surface of the upper casing 60 includes a keyboard detecting area 70, a touchpad detecting area 80 or palm rest detecting areas 90A and 90B.

In order to detect a touch from a user under various operating states, a plurality of touch sensing modules 50E to 50H (which are shown in black blocks in FIG. 2B) are disposed at the inner surface of the upper casing 60.

In the embodiment, the touch sensing modules 50E to 50H are disposed at the inner surface of the upper casing 60. The touch sensing module 50E is disposed at the keyboard detecting area 70 of the upper casing 60 to detect any approach or touch event at the keyboard detecting area 70. Similarly, the touch sensing module 50F and 50H are disposed at the palm rest to detect areas 90A and 90B of the upper casing 60, the touch sensing modules 50F and 50H may detect any approach or touch event at the palm rest detecting areas 90A and 90B. The touch sensing module 50G is disposed at the touchpad detecting area 80 of the upper casing 60 to detect any approach or touch event at the touchpad detecting area 80.

The setting and operating of the touch sensing modules 50A to 50H are illustrated in following. In order to detect an approach or a touch event from the user more effectively, operating modes of the touch sensing modules are determined according to the material of the casing. The touch sensing modules may operate at two detecting modes. A first detecting mode is a capacitive detecting mode. At the mode, the touch sensing modules are disposed at a non-metal casing. When a distance between the user and the detecting area is within a predetermined value (the predetermined value may be 20 mm), the touch sensing modules send out a detecting signal to indicate that the user is approaching. A second detecting mode is a surface detecting mode. At the mode, the touch sensing modules are disposed at a metal or non-metal casing. When the user touches the detecting areas, the touch sensing modules send out a detecting signal.

FIG. 3A is a block diagram showing a circuit of the electronic device in FIG. 1 in a first embodiment. Please refer to FIG. 3A, the electronic device 100A includes a scenario detecting circuit 110, a scenario controller 120, a fan control unit 130, a power control unit 140 and a motherboard 300. The scenario controller 120 is coupled to the scenario detecting circuit 110, the fan control unit 130 and the power control unit 140. The scenario controller 120, the fan control unit 130 and the power control unit 140 are disposed at the motherboard 300.

Please refer to FIG. 1, FIG. 2A, FIG. 2B and FIG. 3A. In the embodiment, the scenario detecting circuit 110 includes the touch sensing modules 50A to 50H. The electronic device 100A includes the casing 200 shown in FIG. 1. The casing of the electronic device 100A corresponds to the bottom casing 10 and the upper casing 60 in FIG. 2A and FIG. 2B.

The scenario controller 120 may be an embedded controller at the motherboard. The fan control unit 130 is a circuit or a mechanism for controlling the operation of a fan. The power control unit 140 is a circuit for controlling power consumption. Thus, the types of the fan control unit 130 and the power control unit 140 are not limited.

The touch sensing modules 50A to 50H are disposed at the inner surface of the casing. The sensing result from the detecting areas is represented by a detecting signal TS. The scenario detecting circuit 110 transmits the detecting signal TS to the scenario controller 120. The scenario controller 120 recognizes the operating state (as shown in FIG. 3B) according to the sensing result (the detecting signal TS) and generates an executable scenario solution. FIG. 3B is a schematic diagram showing operating states in an embodiment. The operating states of the electronic device 100A include a handheld state Z1, a state Z2 when the electronic device is placed at a part of a body, a state Z3 when the electronic device is placed at a constant position (such as a desk) and an object approaches the electronic device or the electronic device is touched, and a state Z4 when the electronic device is placed at a constant position and no object approaches the electronic device or the electronic device is not touched.

Once the executable scenario solution is recognized by the scenario controller 120, the scenario controller 120 transmits control signals CS1 and CS2 to the fan control unit 130 and the power control unit 140 according to the executable scenario solution to adjust the rotating speed of the fan and the operation power consumption of the electronic device 100A. Thus, the electronic device 100A can reduce the surface temperature of the casing which contacts with the user according to the operating state.

FIG. 3C is a block diagram showing a circuit of the electronic device in a second embodiment. The structure of the electronic device 100B is similar to that of the electronic device 100A in FIG. 3A. As shown in FIG. 3C, a fan rotating speed control chart 132 is built in the fan control unit 130A. The fan rotating speed control chart 132 records various scenario solutions and information corresponding to the rotating speed of the fan. The fan control unit 130A controls the heat dissipation of the electronic device 100B according to the control signal CS1 of the scenario controller 120 and the information of the fan rotating speed control chart 132.

In FIG. 3C, a power consumption control chart 142 is built in the power control unit 140A. The power consumption control chart 142 records various scenario solutions and information corresponding to power consumption of various operations. The power control unit 140A controls the heat dissipating of the electronic device 100B according to the control signal CS2 from the scenario controller 120 and the information of the power consumption control chart 142.

The control chart also can be achieved by a plug-in mode. FIG. 3D is a block diagram showing a circuit of the electronic device in a third embodiment. The structure of the electronic device 100C is similar to that of the electronic device 100B in FIG. 3C. The fan rotating speed control chart 134 and the power consumption control chart 144 are set at the motherboard 300. The fan rotating speed control chart 134 records various scenario solutions and information corresponding to the rotating speed of the fan. The power consumption control chart 144 records various scenario solutions and information corresponding to power consumption of various operations. The scenario controller 120 can adjust the rotating speed of the fan and the operation power consumption of the electronic device 100C to control the heat dissipation of the electric device 100C. The fan control unit 130 can control the heat dissipating of the electronic device 100C according to the control signal CS1 from the scenario controller 120 and the information of the fan rotating speed control chart 134, or according to the control signal CS2 from the scenario controller 120 and the information of the power consumption control chart 144.

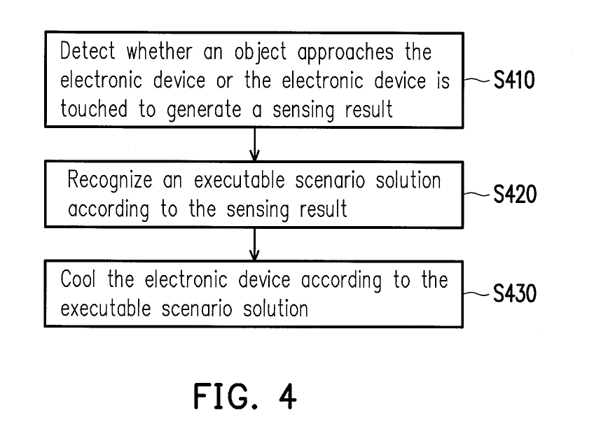

A heat dissipating control method is also provided. FIG. 4 is a flow chart showing a heat dissipating control method in an embodiment. Please refer to FIG. 4, the touch sensing modules 50A to 50H are disposed at the inner surface of the casing of the electronic device to detect whether the user approaches or touches the casing, as shown in FIG. 2A and FIG. 2B.

In step S410, whether an object approaches or touches the electronic device is detected to generate the sensing result.

In step S420, the executable scenario solution is recognized according to the sensing result. The operating state of the user is recognized to generate the executable scenario solution, as shown in FIG. 3A and FIG. 3B.

In step S430, the electronic device is cooled according to the executable scenario solution. The rotating speed of the fan and the operation power consumption of the electronic device can be adjusted.

In sum, the rotating speed of the fan and the operation power consumption of the electronic device are adjusted according to the scenario solutions, which can effectively reduce the surface temperature of the casing which contacts with the user.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A heat dissipating control method applied to an electronic device with a plurality of touch sensing modules comprising following steps:
detecting whether an object approaches the electronic device or the electronic device is touched to generate a sensing result;
recognizing an executable scenario solution according to the sensing result; and
cooling the electronic device according to the executable scenario solution.

2. The heat dissipating control method according to claim 1, wherein the step of cooling the electronic device includes:
adjusting a rotating speed of a fan and an operation power consumption to reduce surface temperature of a casing of the electronic device.

3. The heat dissipating control method according to claim 1, wherein the step of recognizing the executable scenario solution includes:
recognizing which operating state the electronic device is at, and the operating states include a handheld state, a state when the electronic device is placed at a part of a body, a state when the electronic device is placed at a constant position and an object approaches the electronic device or the electronic device is touched, and a state when the electronic device is placed at a constant position and no object approaches the electronic device or the electronic device is not touched.

4. An electronic device comprising:
a casing including a bottom casing and an upper casing to form accommodating space;
a motherboard disposed in the accommodating space;
a scenario detecting circuit including a plurality of touch sensing modules, wherein the touch sensing modules are disposed at an inner surface of the casing, and the scenario detecting circuit detects whether an object approaches the electronic device or the electronic device is touched to generate a sensing result; and
a scenario controller disposed at the motherboard, wherein the scenario controller receives the sensing result, recognizes an executable scenario solution according to the sensing result, and controls the heat dissipating of the electronic device according to the executable scenario solution.

5. The electronic device according to claim 4, wherein the electronic device further includes:
a fan control unit coupled to the scenario controller, wherein the scenario controller controls the fan control unit to adjust a rotating speed of a fan of the electronic device according to the executable scenario solution to reduce surface temperature of a contact area at the casing.

6. The electronic device according to claim 5, wherein the fan control unit includes:
a fan rotating speed control chart for recording multiple scenario solutions and information corresponding to the rotating speed of the fan;
wherein the fan control unit cools the electronic device according to a control signal from the scenario controller and the information of the fan rotating speed control chart.

7. The electronic device according to claim 4, wherein the electronic device further includes:
a power control unit coupled to the scenario controller, wherein the scenario controller controls the power control unit to adjust the operation power consumption according to the executable scenario solution to reduce surface temperature of a contact area of the casing.

8. The electronic device according to claim 7, wherein the power control unit includes:
a power consumption control chart for recording multiple scenario solutions and information corresponding to power consumption of various operations;
wherein the power control unit cools the electronic device according to a control signal from the scenario controller and the information of the power consumption control chart.

9. The electronic device according to claim 4, wherein the electronic device further includes:
a fan control unit coupled to the scenario controller; and
a power control unit coupled to the scenario controller;
wherein the scenario controller controls the power control unit to adjust the rotating speed of the fan and the operation power consumption according to the executable scenario solution to reduce surface temperature of a contact area of the casing.

10. The electronic device according to claim 4, wherein touch detecting areas at an outer surface of the bottom casing includes at least a first side detecting area, a middle detecting area or a second side detecting area, and the touch sensing modules are disposed corresponding to the first side detecting area, the middle detecting area and the second side detecting area.

11. The electronic device according to claim 4, wherein touch detecting areas at an outer surface of the upper casing includes at least a keyboard detecting area, a touchpad detecting area or a palm rest detecting area, and the touch sensing modules are disposed corresponding to the keyboard detecting area, the touchpad detecting area and the palm rest detecting area.

12. The electronic device according to claim 4, wherein the scenario controller recognizes which operating state the electronic device is at according to the sensing result from the touch sensing modules, and the operating states include a handheld state, a state when the electronic device is placed at a part of a body, a state when the electronic device is placed at a constant position and an object approaches the electronic device or the electronic device is touched, and a state when the electronic device is placed at a constant position and no object approaches the electronic device or the electronic device is not touched.

13. The electronic device according to claim 4, wherein when the touch sensing modules are at a capacitive detecting mode and a distance between a user and the touch sensing modules is within a predetermined value, the touch sensing modules sends out a detecting signal.

14. The electronic device according to claim 4, wherein when the touch sensing modules are at a surface detecting mode and the casing is touched, the touch sensing modules sends out a detecting signal.
